(19) United States
(12) Patent Application Publication
(10) Pub. No.: US 2022/0023948 A1
(43) Pub. Date: Jan. 27, 2022

(54) REPAIR PROCESS USING LASER METAL POWDER DEPOSITION

(71) Applicant: Westinghouse Electric Belgium, Nivelles (BE)

(72) Inventors: Cindy MUYLLE, Jurbise (BE); Yves DERRIENNIC, Uccle (BE); Gisele WALMAG, Tilff (BE); Norberto JIMENEZ, Liege (BE); Cedric GEORGES, Noville-les-bois (BE)

(73) Assignee: Westinghouse Electric Belgium, Nivelles (BE)

(21) Appl. No.: 17/294,555

(22) PCT Filed: Nov. 15, 2018
(86) PCT No.: PCT/EP2018/081351

§ 371 Date: May 17, 2021

(51) Int. Cl. B22F 10/28; B22F 12/41; B22F 10/66; B23P 6/04; B33Y 10/00; B33Y 70/00

(52) U.S. Cl. CPC B22F 10/28; B22F 12/41; B22F 10/66; B22F 2301/35; B33Y 10/00; B33Y 70/00; B23P 6/04

(57) ABSTRACT

A laser metal powder deposition method is described which can be utilized for the repair of cast stainless steel components used in nuclear environments. Internal defects found in a component (200) during routine maintenance and refurbishment are identified and then excavated to form a cavity (210). The cavity is filled by multiple layers (310₁, 310₂, . . . , 310_{N}) of laser metal powder deposition and then checked for its integrity.

### CROSS-REFERENCE TO RELATED APPLICATION

This application is a U.S. National Stage Entry under 35 U.S.C. § 371 of International Patent Application No. PCT/EP2018/081351, entitled “REPAIR PROCESS USING LASER METAL POWDER DEPOSITION,”, filed Nov. 15, 2018, the entire disclosure of which is hereby incorporated by reference herein.

### FIELD OF THE DISCLOSURE

The present disclosure relates to a repair process using laser metal powder deposition, and is more particularly, although not exclusively, concerned with repairing nuclear cast stainless steel cast components.

### BACKGROUND OF THE DISCLOSURE

Laser-based technologies, such as laser cladding and laser metal deposition, have become an established technology for parts repair and surface modification of cost-intensive components. Due to continuing improvements of laser sources, process technology and strategy, the range of applications for laser deposition processes is continuously increasing.

U.S. Pat. No. 7,169,242 discloses a method for removing casting defects from an article with an oriented microstructure. The method includes melting an identified casting defect locally by a heat source to a depth at least as deep as the casting defect itself, and solidifying the molten material epitaxially with respect to the surrounding oriented microstructure of the article which is substantially free of casting defects. In this method, the material itself is used to fill the casting defect when it is re-solidified.

US-A-2016/0243650 discloses a method of reworking a component manufactured of a non-fusion weldable base alloy to remove a casting defect. The method comprises forming a cavity in the component at the location of the casting defect and at least partially filling the cavity with multiple of layers each comprising multiple of laser powder deposition spots. Each of the multiple of laser powder deposition spots is formed of a filler alloy.

Nuclear cast stainless steel components are regularly inspected using non-destructive testing techniques, and, internal and/or surface defects are often detected during routine inspections. At present, it is not possible to repair such internal and/or surface defects using conventional welding processes due to complex geometry of the components and the associated strict manufacturing tolerances which are associated with nuclear cast stainless steel components. The result is that, instead of repairing a component due to internal and/or surface defects, replacement of the entire component is the only option. This scrapped or discarded component then forms a source of secondary radioactive waste.

There is therefore a need to be able to repair internal and/or surface defects in nuclear cast stainless steel components so that replacement is no longer necessary in the majority of cases.

### SUMMARY OF THE DISCLOSURE

It is an object of the present disclosure to reduce secondary radioactive waste by repairing components in the nuclear environment instead of scrapping them.

It is another object of the present disclosure to provide a method of repairing cast stainless steel components suitable for use in a nuclear environment.

In accordance with one aspect of the present disclosure, there is provided a method of repairing a cast stainless steel component, the method comprising the steps of:

a) identifying the presence of at least one defect in the cast stainless steel component;

b) excavating a region in the cast stainless steel component which includes the at least one identified defect to form a cavity;

c) depositing laser metal powder within the cavity in a predetermined pattern;

d) melting and fusing the deposited laser metal powder within the cavity using a laser, and

e) finishing the surface of the filled cavity to match the surface of the cast stainless steel component.

By using a laser metal powder deposition process to fill the excavated cavity, the strains and stresses in the component are carefully controlled which results in minimization of deformations and distortions in the repaired component.

In an embodiment, the method further comprises the step of cleaning the cavity prior to step c).

This ensures that any loose material within the cavity is removed prior to filling so that further defects are not created during the laser metal powder deposition process.

In an embodiment, steps c) and d) are repeated more than once.

Each repetition of steps c) and d) builds a layer within the cavity. This ensures that the excavated cavity is completely filled.

In an embodiment, step b) may comprise using non-destructive testing to control the excavation of the region including the defect.

By using non-destructive testing in this way, accurate control is provided to ensure that the defect is included in the excavation and that no more than necessary material is excavated from the region.

In an embodiment, step e) comprises a mechanical finishing step.

By mechanical finishing, the surface of the component in the region of the excavation can readily be returned to almost its original state prior to excavation.

In an embodiment, a further step may comprise the step of checking that the repair conforms with the rest of the cast stainless steel component.

This is important in a nuclear environment where integrity and dimensional tolerances are important.

### BRIEF DESCRIPTION OF THE DRAWINGS

For a better understanding of the present disclosure, reference will now be made, by way of example, to the accompanying drawings in which:

FIG. 1 illustrates a flow chart of a repair process for nuclear cast stainless steel components;

FIG. 2 is a schematic illustration of a portion of a component which has been excavated in order to remove a defect;

FIG. 3 is a sectioned side view illustrating an excavation in the component to be repaired;

FIG. 4 is a top view of the excavation of FIG. 3;

FIG. 6 is similar to FIG. 4 but illustrates the laser metal powder deposition passes in the excavation.

### DESCRIPTION OF THE DISCLOSURE

The present disclosure will be described with respect to particular embodiments and with reference to certain drawings but the disclosure is not limited thereto. The drawings described are only schematic and are non-limiting. In the drawings, the size of some of the elements may be exaggerated and not drawn on scale for illustrative purposes.

Non-destructive testing (NDT) techniques are used for checking the integrity of nuclear cast stainless steel components. NDT techniques utilize electromagnetic radiation, sound and other signal conversions for examining a wide variety of articles or components for integrity, composition or condition without altering the state of article or component itself. Liquid penetrant testing may also be used. Visual inspection, enhanced by the use of magnifiers, cameras or other optical arrangements is the most common form of NDT. However, visual inspection is limited to surface or external regions of articles or components being tested. Radiographic testing using penetrating radiation, for example, X-rays, neutrons and gamma radiation may provide for volumetric examination of the internal structure of an article or component. Ultrasonic testing using ultrasound systems may also be used. For example, ultrasound transducers emit sound waves for volumetric examination of articles or components and reflected sound waves from articles or components being tested are evaluated for changes in amplitude etc. Articles or components made of ferrous materials can also be tested by applying iron particles thereto and applying a magnetic field to the article or component to identify any leakage in the magnetic field due to an internal defect. As such techniques are widely known, no further description is given below.

The expression “laser metal powder” as used herein refers to the metal powders used for three-dimensional printing or rapid prototyping where a high power-density laser is used to melt and fuse metallic powders together. Such a process is known as “selective laser melting” (or more broadly “selective laser sintering”) where thin layers of metal powder are evenly distributed onto a substrate plate which is indexed along a vertical axis. Once each layer has been distributed, each two-dimensional slice of the part geometry is fused by selectively melting the metal powder before repeating for subsequent layers.

A typical stainless steel alloy which can be used for “selective laser melting” is 17-4 stainless steel (also known as UNS17400), a grade of martensitic precipitation-hardened stainless steel (which is magnetic) containing 15 to 17.5% chromium and 3 to 5% nickel (sometimes known as 15-5 stainless steel). 3 to 5% of copper may also be present in the alloy. Such a stainless steel alloy can be heat-treated to high levels of strength and hardness, featuring higher corrosion resistance and machinability compared to the most common stainless steel (UNS S30400, also known as 18-8 stainless steel having 18 to 20% chromium and 8 to 10.5% nickel, which is austenitic).

However, other stainless steel alloys, such as type 316L (UNS S31603) austenitic stainless steel, may also be used depending on the material from which the component is made. Type 316L contains between 2 and 3% molybdenum which increases corrosion resistance and provides increased strength at high temperatures.

The expression “laser metal powder deposition” as used herein refers to the depositing at least one layer of laser metal powder on a substrate followed by melting and fusing of the layer of laser metal powder. Typically, multiple layers are deposited to fill an excavated cavity as described in more detail below.

The term “defect” as used herein refers to both internal defects and surface defects which may be present in a cast stainless steel component.

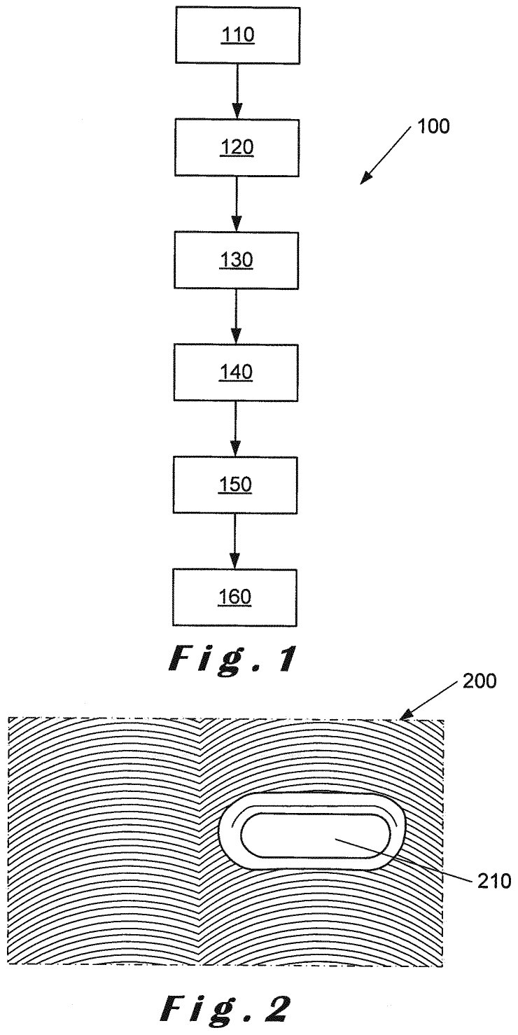

FIG. 1 illustrates a flow chart 100 of a process for detecting and repairing internal defects in cast stainless steel components, and, in particular in, cast stainless steel components used in a nuclear environment, for example, a reactor coolant pump. The first step, step 110, comprises NDT of the component to identify any internal defects. Such internal defects may be arise as a result of original manufacturing and/or subsequent repair. Moreover, such internal defects may have developed within the component since the last NDT inspection and are located during a subsequent NDT inspection. Depending on the type of component, several of the NDT techniques described above may be used.

Having identified an internal defect, a region including the defect is excavated, step 120, to form a cavity. Such excavations may be performed by machining or grinding to remove the non-acceptable defects. Typically, a set of excavations is used, for example, geometrical sets, which allow the defect to be reached from the surface of the component. The excavation is controlled by NDT examination to ensure that all of the defect(s) is removed in the excavation process.

In one embodiment, as described below with reference to FIGS. 2 to 6, the geometrical set may comprise a series of rounded oblongs or elongated circles, that is, circles which have been divided in two along a diameter and elongated to include a rectangle between the two halves of the divided circle of differing sizes. Such a series of rounded oblongs or elongated circles may form a stadium where the base thereof has the smallest dimensions and the top surface thereof has the largest dimensions with a gradual change in dimensions from the base to the top surface to form a graded or sloped wall. Typical stadia or stadiums may be circular or elliptical (or elongated circles as described above).

The excavated region or cavity is cleaned, step 130, to ensure that any foreign material that may have entered the excavated region or cavity is removed prior to depositing multiple layers of laser metal powder deposition, step 140, into the excavated region or cavity. The laser metal powder deposition step deposits type 316L stainless steel metal powder as described above into the excavated region or cavity in specific paths or patterns and then the deposited powder is heated and melted by a laser in a neutral gas environment to fill the excavated region or cavity. Several passes are normally required to ensure that the excavated region or cavity is fully replenished with the filler material, that is, the melted powder, by building up multiple layers. Visual monitoring is used during the laser metal deposition to ensure that the cavity is being correctly filled.

Naturally, the laser metal powder used is chosen to match the material from which the original cast component has been made.

Once the excavated region or cavity has been filled by the deposition of multiple layers of laser metal powder, the surface of the component is finished, step 150, so that it conforms with the rest of the component. The finishing step comprises mechanical finishing, for example, polishing or grinding, to provide the required surface requirements.

After finishing, the region where the original defect was detected is checked again using NDT, step 160. This ensures that the repair meets the requirements with dimensional and geometrical controls to ensure that tight tolerances are maintained for the particular component.

The method can then be repeated for other identified defects in the article or component.

FIG. 2 illustrates a plan view of a portion of an article or component 200 in which an excavation region or cavity 210 has been made to remove a defect. In this case, the excavation region or cavity 210 at the surface of the component can be considered to be an elongated circle as described above. However, other suitable profiles can be used for the excavation regions or cavities.

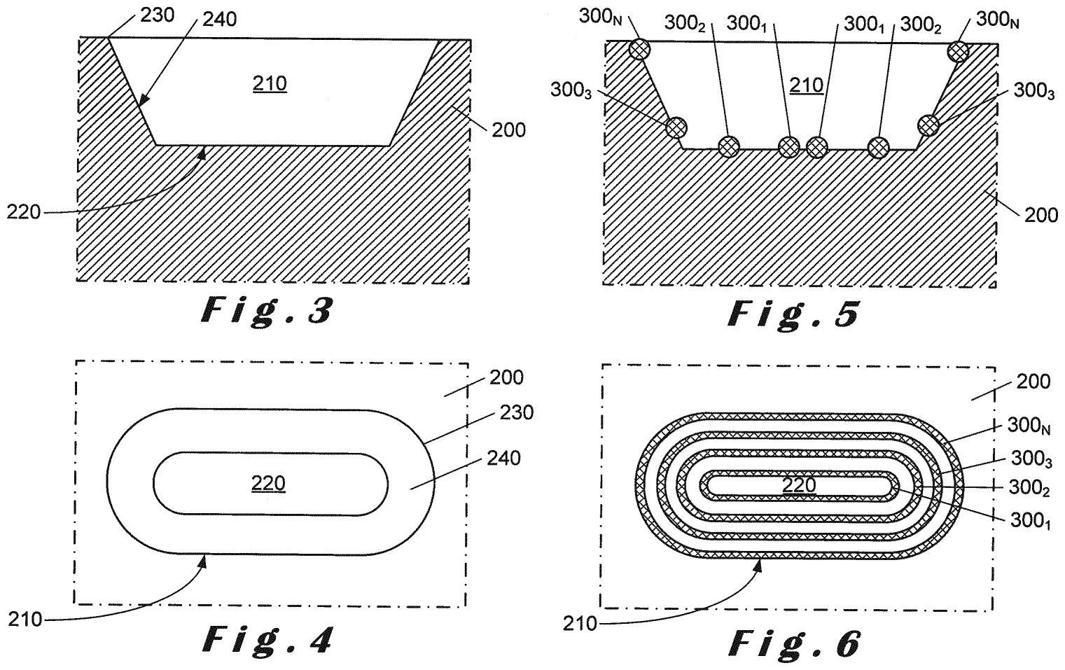

FIG. 3 illustrates a sectioned side view of the portion of the article or component 200 showing the excavation region or cavity 210 in more detail. In this case, the excavation region or cavity 210 has a base portion 220 which extends to a surface portion 230 by means of a sloping wall or banked portion 240.

In FIG. 4, the component 200 and the excavation region or cavity is shown in plan view. As shown, the base portion 220 also comprises an elongated circle but having smaller dimensions than that of the elongated circle forming the surface portion 230 and is centrally located within the surface portion 230 and is connected thereto by the sloping wall or banked portion 240. Although, in this example, the base portion 220 is shown to be centrally located within the surface portion 230, it is not essential that the central location is present and there may be some offset between the base portion and the surface portion.

FIG. 5 is similar to FIG. 3 but also illustrates a number of laser metal powder deposition passes 300₁, 300₂, 300₃, . . . , 300_{N}, where N is shown as being 4 in this specific example, on the base portion 220 and the sloping wall or banked portion 240 up to the surface portion 230. Naturally, N can be any suitable value, and, there are multiple layers of passes required to fill the excavation region or cavity 210. Each pass follows a path which is similar to the shape of the base portion 220 of the cavity 210, that is, one of a series of rounded oblongs or elongated circles which together fill the cavity 210.

FIG. 6 is similar to FIG. 4 but illustrates a number of laser metal powder deposition passes 300₁, 300₂, 300₃, . . . , 300_{N} in the excavated region or cavity 210. Again, N is shown as being 4 but can be any suitable value necessary to fill the excavation region or cavity 210.

When performing the laser metal powder deposition steps or passes, the minimum laser speed required is at least 1000 mm/min (or around 16.5 mm/s). The time taken to fill a cavity 20 mm long by 10 mm wide by 5 mm deep is between 1 and 4 minutes with extra time being needed for the preparation of the filling, positioning the laser with respect to the component being repaired, programming the laser and establishing a neutral gas environment in which the laser metal powder deposition is performed etc.

The laser may be used vertically, that is, perpendicularly to, the surface of the component being repaired, but other angles may also be possible in combination with the injection direction of the laser metal powder.

An example of where the method of the present disclosure can be used is in the refurbishment of nuclear reactor coolant pumps (RCP). The process of refurbishment includes decontamination, disassembly and inspection followed by component repair, or replacement if necessary, then reassembly. Depending on inspection results, some components may be found to have defects which require repair, typically using a welding process.

However, in the nuclear environment, the main risk produced by repairing a component using a welding process is deformation of the component being repaired. As tolerances on components used in the nuclear environment are tight, welding may result in a distorted component which has localized deformation due to local heating at the welding site. Such localized deformation may result in incompatible deformations. The result of such incompatible deformations is that the component is no longer useful without having further modifications and is often scrapped. In addition, as a high volume of material tends to be required for a welding process, post-welding machining is mandatory for the recovery of an acceptable surface status and dimensional size of the repaired component.

Laser metal powder deposition for repairing components of RCP is advantageous over conventional welding repair as the deposition parameters can be carefully monitored or controlled to ensure that quality is maintained. As there is a limited heat affected zone (HAZ), strains and stresses applied to the component during laser metal powder deposition are clearly less than those applied during conventional welding processes. Moreover, by limiting the strains or stresses, the component being repaired is not deformed as much as in conventional welding processes. Furthermore, the amount of post-machining required after laser metal powder deposition is less than that required after welding. By repairing a component using laser metal powder deposition instead of scrapping it, contaminated waste is reduced.

Being able to repair nuclear cast stainless steel components, there is an increased availability of components as it is no longer necessary to replace the component thereby avoiding long lead times for manufacturing a replacement component.

As the component is repaired instead of being scrapped, secondary radioactive waste is significantly reduced. Furthermore, spare parts management is improved.

Other components used in the nuclear environment which may be repaired using the method of the present disclosure include, but are not limited to, diffusers, valves and shafts.

What is claimed is:

1. A method of repairing a cast stainless steel component, the method comprising the steps of:
a) identifying the presence of at least one defect in the cast stainless steel component;
b) excavating a region in the cast stainless steel component which includes the at least one identified defect to form a cavity;
c) depositing laser metal powder within the cavity in a predetermined pattern;
d) melting and fusing the deposited powder within the cavity using a laser; and
e) finishing the surface of the filled cavity to match the surface of the cast stainless steel component.

2. A method according to claim 1, further comprising the step of cleaning the cavity prior to step c).

3. A method according to claim 1 or 2, further comprising repeating steps c) and d) more than once.

4. A method according to claim 3, wherein each repetition of steps c) and d) builds a metal layer within the cavity.

5. A method according to any one of claims 1 to 4, wherein step b) comprises using non-destructive testing to control the excavation of the region including the defect.

6. A method according to any one of claims 1 to 5, wherein step e) comprises a mechanical finishing step.

7. A method according to any one of claims 1 to 6, further comprising the step of checking that the repair conforms with the rest of the cast stainless steel component.
